(19) United States
(12) Patent Application Publication
(10) Pub. No.: US 2003/0236893 A1
(43) Pub. Date: Dec. 25, 2003

(54) Portable terminal, server and program

(76) Inventor: Hideki Nakamura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/429,788

(22) Filed: May 6, 2003

(30) Foreign Application Priority Data
May 7, 2002 (JP) 2002-131097

(51) Int. Cl. G06F 15/16

(52) U.S. Cl. 709/228

(57) ABSTRACT

A portable terminal, a server and a program have the function of automatic execution of an application, for the portable terminal having the function of measuring the present place, using the present place of the portable terminal or both the present place and the present time of the portable terminal as a trigger. The portable terminal includes a registration unit for registering the place condition and the time condition making up conditions for automatic execution and an application to be automatically executed, a position information acquisition unit for acquiring the present place of the portable terminal itself, a present time acquisition unit for acquiring the present time, and a control unit for executing the registered application in the case where the place condition registered as an acquired present place and the acquired present time satisfies the time condition registered.

### BACKGROUND OF THE INVENTION

1. Field of the Invention

The present invention relates to the function of automatically executing an application (application program) in a portable terminal.

2. Description of the Related Art

In the portable telephone currently used, an environment for executing an application described in Java (registered trade mark of Sun Microsystems, US) can be mounted as a standard. Java is a program language whereby a program not dependent on the equipment can be generated. As an environment allowing a Java application to be executed (the Java executable environment) is mounted in a portable telephone, the user can execute by downloading a preferred program onto the portable telephone in the same manner as in a PC or the like.

The above-mentioned portable telephone with the Java executable environment mounted therein has the function of automatically executing an application. This function is for automatically executing a user-designated application upon arrival of the time designated by the user. Using this function, an application can be automatically executed so that the portable telephone can be used like an alarm clock, for example.

### SUMMARY OF THE INVENTION

With the portable telephone currently in use, an application is executed automatically by designating only the time. For executing an application to indicate a time table upon arrival at a railway station, for example, the user is required to take the trouble of executing the application each time the user arrives at a station. This imposes a burden on the user. As described above, the conventional portable telephone lacks the ability of automatic execution of an application based on a geographical space, i.e. on condition that a specific place is entered. This gives rise to the problem of the inconvenience on the part of the user.

The present invention has been developed in view of the above-mentioned problem, and the object thereof is to provide a portable terminal, a server and a program, wherein a portable terminal having the function of measuring the present place is realized with the function of automatically executing an application adapted to be triggered by the present place of the portable terminal or both the present place of the portable terminal and the present time for an improved convenience of the user.

In order to achieve the above-mentioned object, according to this invention, there is provided a portable terminal capable of registering an application, comprising:

(1) an execution condition registration unit for registering the condition for the place of automatic execution, the condition for the time of automatic execution and an application to be automatically executed;

(2) a position information acquisition unit for acquiring the position information whereby the present place can be specified;

(3) a present time acquisition unit whereby the present time can be acquired; and

(4) a control unit for comparing the present place and the present time with the position condition and the time condition, respectively, held in (1) above, and in the case where the conditions are met, executing the application designated in (1) above.

Before use of the portable terminal according to this invention, the place condition and the time condition for automatic execution and an application to be automatically executed are registered in the portable terminal by the execution condition registration unit. Then, the position information permitting the present place of the portable terminal to be specified is acquired by the position information acquisition unit. Next, the control unit executes the registered application in the case where the position information and the present time acquired at regular time intervals meet the condition for automatic execution registered in the execution condition registration unit.

As a result, an application can be executed automatically with the present place of the portable terminal as a trigger. The present place as well as the present time can be used as a trigger for automatic execution. Therefore, an application to be executed can be varied depending on the present place, and therefore a more detailed setting by the user is made possible for an improved convenience of the user.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for explaining an outline of an embodiment realized by a portable terminal unit according to the invention.

FIG. 2 is a diagram showing a data structure of an application realizable with a portable terminal unit according to an embodiment of the invention.

FIG. 3 is a diagram for explaining a hardware configuration of a portable terminal realizable with a portable terminal unit according to an embodiment of the invention.

FIG. 4 is a diagram for explaining a hardware configuration of a portable terminal in an embodiment realizable with a portable terminal unit and capable of setting the time condition according to the invention.

FIG. 5 is a diagram for explaining an example display of a setting screen for automatic execution in an embodiment realizable with a portable terminal unit according to the invention.

FIG. 6 is a diagram for explaining an example display of a map input screen of a center point in an embodiment realizable with a portable terminal unit according to the invention.

FIG. 7 is a diagram for explaining an example display of a select screen of an application to be executed realizable in an embodiment with a portable terminal unit according to the invention.

FIG. 8 is a diagram for explaining a structure of the data registered for automatic execution in an embodiment realizable with a portable terminal unit according to the invention.

FIG. 9 is a diagram for explaining an example display of a setting screen for automatic execution in an embodiment realizable with a portable terminal unit and capable of setting the time condition according to the invention.

FIG. 10 is a diagram for explaining a structure of the data registered for automatic execution in an embodiment realizable with a portable terminal and capable of setting the time condition according to the invention.

FIG. 11 is a flowchart for explaining the processing for automatic execution of an application used in an embodiment realizable with a portable terminal unit according to the invention.

FIG. 12 is a flowchart for explaining the processing for automatic execution of an application used in an embodiment realizable with a portable terminal unit and capable of setting the time condition according to the invention.

FIG. 13 is a diagram for explaining an outline of an embodiment realizable with a portable terminal and a server according to the invention.

FIG. 14 is a diagram for explaining a hardware configuration of a portable terminal in an embodiment realizable with a portable terminal and a server according to the invention.

FIG. 15 is a diagram for explaining a hardware configuration of a portable terminal in an embodiment realizable with a portable terminal and a server and capable of setting the time condition according to the invention.

FIG. 16 is a diagram for explaining a structure of the data registered for automatic execution used in an embodiment realizable with a portable terminal and a server according to the invention.

FIG. 17 is a diagram for explaining a data structure of a registration table for automatic execution used in an embodiment realizable with a portable terminal and a server according to the invention.

FIG. 18 is a flowchart for explaining the processing for automatic execution of an application used in an embodiment realizable with a portable terminal and a server according to the invention.

FIG. 19 is a diagram for explaining a data structure of a position information message used in an embodiment realizable with a portable terminal and a server according to the invention.

FIG. 20 is a diagram for explaining a data structure of an application execution request message used in an embodiment realizable with a portable terminal and a server according to the invention.

FIG. 21 is a flowchart for explaining the processing for automatic execution of an application used in an embodiment realizable with a portable terminal and a server and capable of setting the time condition according to the invention.

### DESCRIPTION OF THE EMBODIMENTS

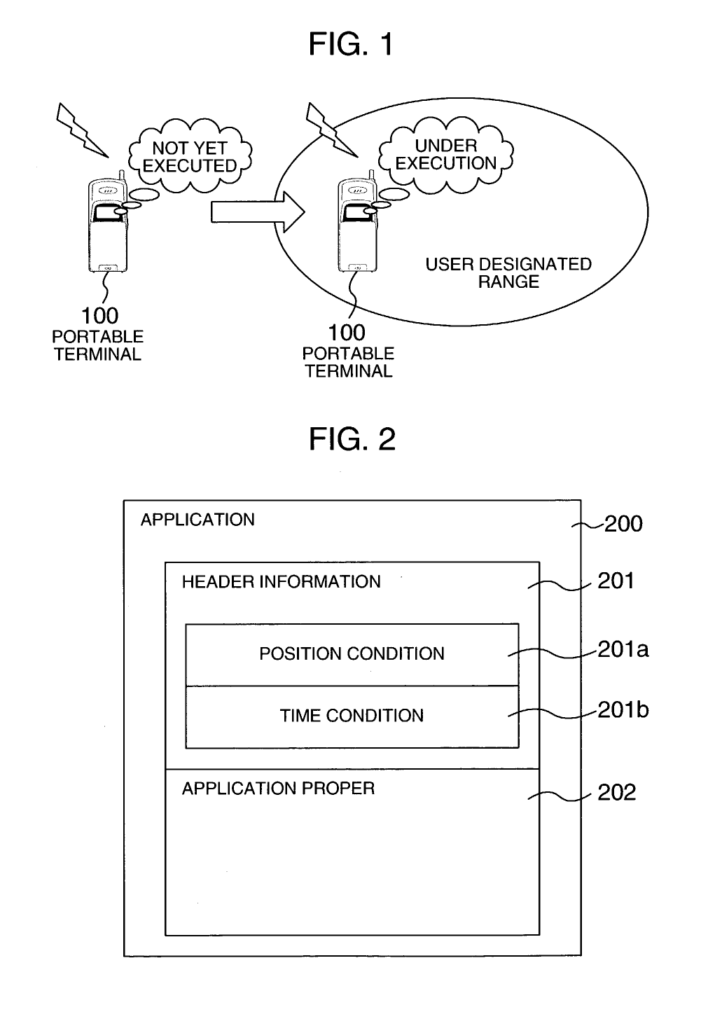

First, an outline of an embodiment in which an application is automatically executed with a portable terminal unit according to the invention will be explained with reference to FIG. 1.

In FIG. 1, reference numeral 100 designates a portable terminal. The portable terminal 100 includes a present place acquisition unit for acquiring the present place of the portable terminal. The present place acquisition unit is represented by, for example, a device for acquiring the present place of the portable terminal using the GPS (global positioning system). Assume that an application to be executed is stored in the portable terminal 100 in advance. An application to be executed and the condition for the place where the application is executed (hereinafter referred to as the position condition) are registered in the portable terminal 100. Then, the portable terminal 100 holds an identifier for uniquely identifying the position condition and the application to be executed (hereinafter referred to as the application ID).

The portable terminal 100 is equipped with an execution condition determination processing for determining whether the present place acquired by the present place acquisition unit meets the registered position condition or not, and only in the case where the position condition is met, an application corresponding to the registered application ID is executed.

The portable terminal 100 has a present time acquisition unit for acquiring the present time, and the condition for the time of execution (hereinafter referred to as the time condition) is added as a condition for executing an application registered. Then, a configuration can be employed in which it is determined in the execution condition determination processing whether the acquired present place and the acquired present time satisfy the registered position condition and the registered time condition, respectively. In the case where the acquired present place and the acquired present time satisfy the position condition and the time condition, respectively, an application corresponding to the application ID registered is executed.

In a method of registering the position condition making up a condition for executing an application in the portable terminal 100, the position condition may be input directly using an input device or using the following-described header information of the application.

Generally, as shown in FIG. 2, an application 200 is configured of two component elements including header information 201 and an application proper 202. The header information 201 includes the description of various information on the application 200 such as the version information, the file name and the updated date of the application. The application proper 202 is a collection of program codes for activating the application. The header information 201 and the application proper 202 may be arranged collectively in a single file or separately in a file for storing the header information 201 and a file for storing the application proper 202, respectively. In the header information 201, an application producer stores a position condition data 201a for storing the position condition desired for automatic execution of the application and a time condition data 201b for storing the time condition desired for automatic execution of the application. These data may be registered in the portable terminal 100 without the input operation of the user as a position condition and a time condition making up the conditions for automatic execution of the application. Consider, for example, an application of which the activation is desired in the case where the portable terminal 100 is located “within the radius of 200 m from Totsuka Station” at time “7:30 p.m.”. The producer of this application describes “AreaCondition:E139.32.14.4,N35.23.50.1,200m” as the position condition data 201a and “TimeCondition:0730” as the time condition data 201b in the header information 201 of the application. In the case where the user downloads this application to the portable terminal 100 and sets the portable terminal 100 for permission of automatic execution of the application, then the position condition data 201a and the time condition data 201b in the header information are registered in the portable terminal 100 as a position condition and a time condition, respectively, making up the conditions for automatic execution of the application. Following this procedure, the position condition and the time condition making up the conditions for automatic execution are registered in the portable terminal 100 using the data in the header information.

In this way, the function of automatically executing an application with the present place as a trigger can be realized with a portable terminal unit.

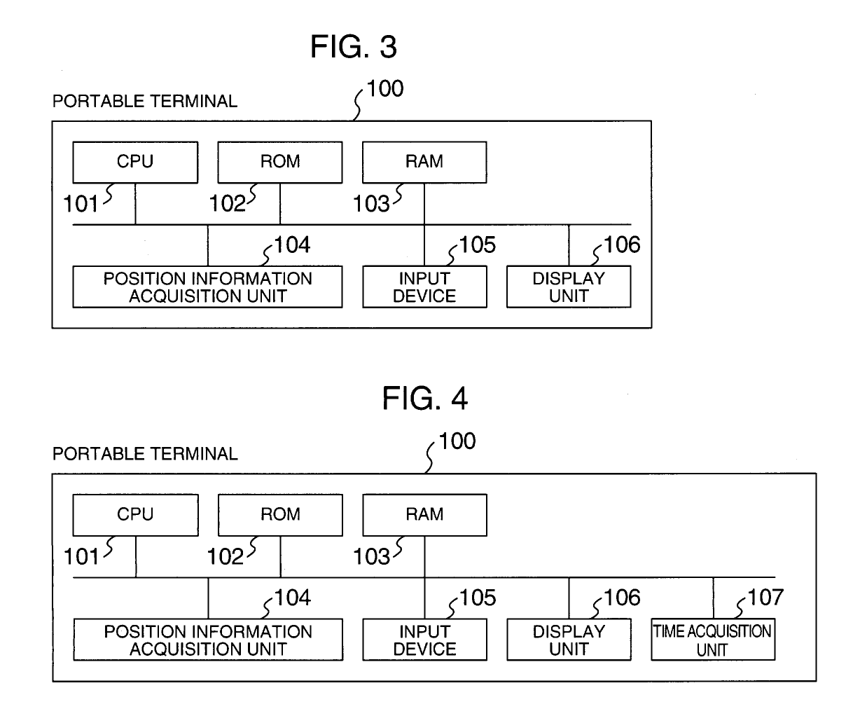

Next, a hardware configuration of a portable terminal according to this invention will be explained with reference to FIGS. 3 and 4.

In FIG. 3, numeral 101 designates a CPU (central processing unit) for executing various programs relating to the control of the peripheral units, the data processing and the calculation of the present place. Numeral 102 designates a ROM (read-only memory) for storing various programs and data to process the data and calculate the present place. Numeral 103 designates a RAM (random access memory) used for executing by loading various programs for data processing and calculation of the present place from the ROM or storing the data. Numeral 104 designates a position information acquisition unit used for acquiring the position information capable of specifying the present place. The position information acquisition unit 104 is a GPS system, for example. Numeral 105 designates an input device used for operation of an application to be executed and various setting processes. The input device 105 is a button or a joystick, for example. Numeral 106 designates a display unit used for displaying a setting screen to change the setting for automatic execution of an application or displaying an application executed in the portable terminal 100. The display unit 106 is a LCD (liquid crystal display), for example.

In the case where the time as well as the place is taken into consideration for determining whether an application is to be automatically executed or not, the hardware configuration of the portable terminal is employed as shown in FIG. 4. A time acquisition unit 107 used for acquiring the present time is added to the portable terminal shown in FIG. 3.

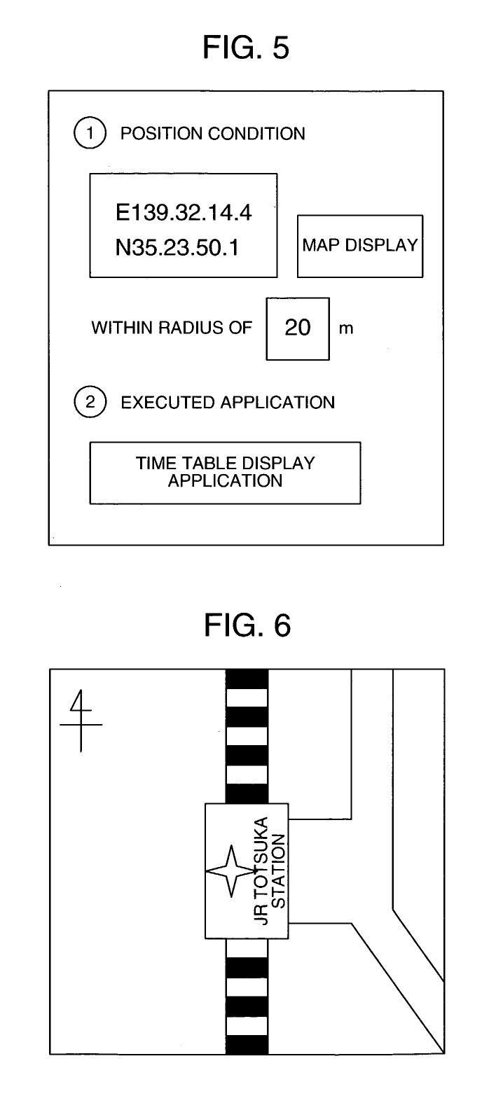

Next, the process for registering the position condition or an application to be automatically executed in the portable terminal 100 will be explained with reference to FIGS. 5, 6, 7, 8, 9 and 10.

The user can display an automatic execution setting screen as shown in FIG. 5 by operating the input device 105 of the portable terminal 100. In this setting screen, the user inputs the position condition making up a condition for automatic execution and an application to be automatically executed, and in the case where the input condition is met, the designated application can be automatically executed.

First, a method of inputting the position condition will be explained with reference to a case in which the designation of an area within the radius of 20 m from JR Totsuka Station is desired. The position of JR Totsuka Station constituting the center point of the position condition is input. The center point is input in terms of map, address, facility name, etc. constituting common input items in a car navigation system. In the case under consideration, an explanation will be given of a method of selecting the position of JR Totsuka Station in terms of map. Upon selection of a on-map input as an input scheme, the map is displayed as shown in FIG. 6. The cursor displayed on the screen is moved using the input device 105 to a place constituting a candidate center point. The cursor position is set to the place constituting the candidate center point, which place is set as a center point using the input device 105. The latitude and longitude data corresponding to the cursor position are registered, and the facility name corresponding to the cursor position is displayed on the setting screen. The center point is input in this way. Next, the range associated with the position condition, i.e. the radius from the center point is input. The radius is input directly with a numerical character such as “20” from the input device 105 or by selecting “20 m” from a list of numerical values displayed on a combo box.

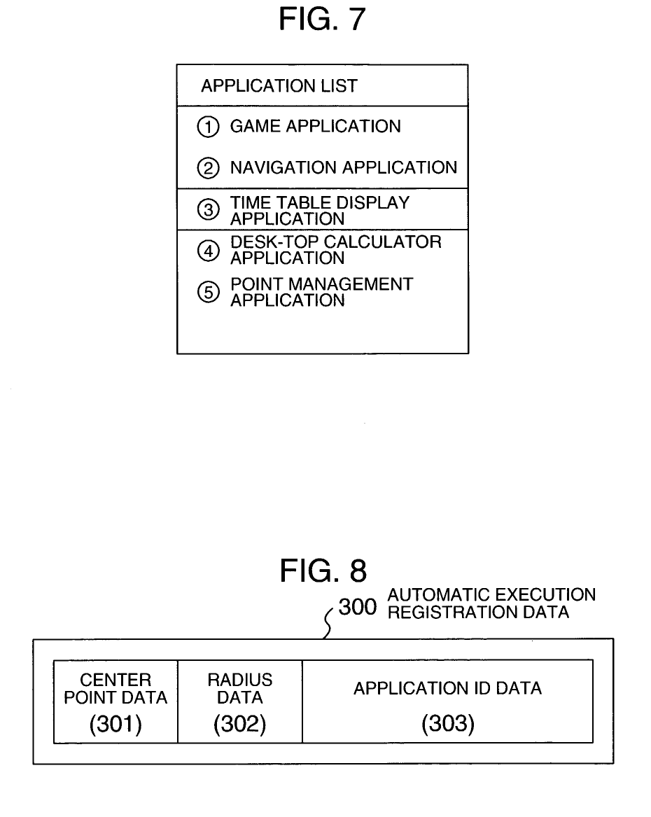

Next, an application to be automatically executed is input by selecting an application of which automatic execution is desired from the screen listing the applications stored in the portable terminal 100 as shown in FIG. 7.

Once the aforementioned setting is registered, an automatic execution registration data 300 is stored in the portable terminal 100 as shown in FIG. 8. The automatic execution registration data 300 is configured of a center point data 301, a radius data 302 and an application ID data 303. The position condition input by the registration process described above is stored in the center point data and the radius data, the time condition in the execution time data, and the application to be automatically executed in the application ID data as an application data. The automatic execution of the application is controlled using the automatic execution registration data 300.

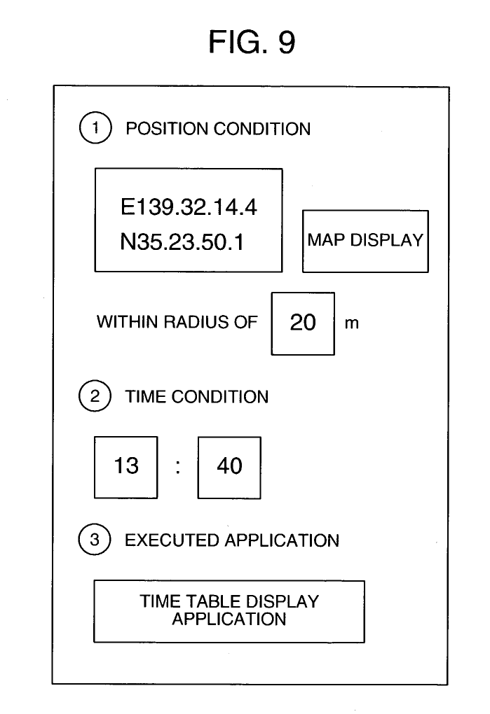

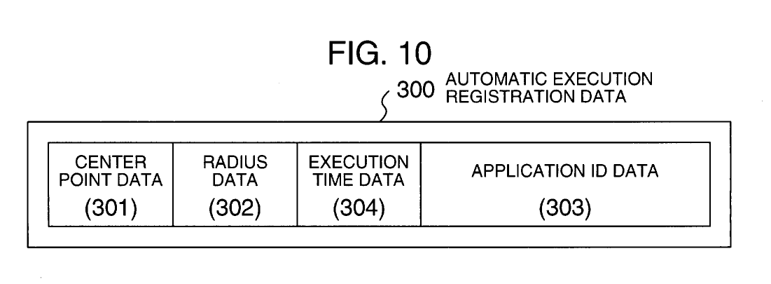

In the case where the time is added as a condition for automatic execution of an application, a column for inputting the time condition is added as shown in FIG. 9. The time condition is input in terms of a desired operation time from the input device 105. In the case where the time condition is not set, on the other hand, no time condition is input for registration. Also, an execution time data 304 is added to the automatic registration data 300 as shown in FIG. 10. This execution time data 304 has stored therein the input time condition and used for automatic execution of an application.

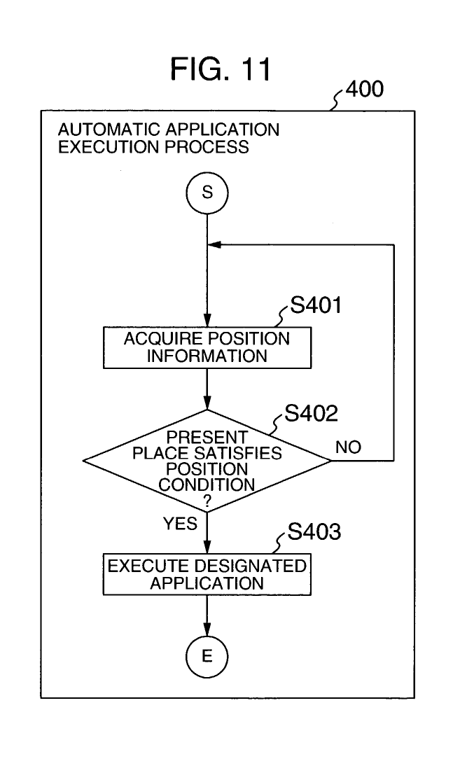

Next, the automatic execution processing 400 for an application registered in the portable terminal 100 will be explained with reference to FIG. 11.

The portable terminal 100 acquires the position information with which the present place can be specified regularly using the position information acquisition unit 104 (step S401). The position condition determination processing for determining whether the acquired position information meets the position condition or not (step S402). In this determination processing, the distance between a designated position and the present place is calculated, and it is determined whether the distance is smaller than the radius designated in the position condition. A specific explanation will be given of the determination, for example, for the position condition specifying an area within the radius of 100 m from the designated position as a center. In this case, assume that the position information acquired in step S401 is Long. 139.32.14.4 E, Lat. 35.23.50.1 N. The distance from the center point to the present place is calculated as 200 m and exceeds the radius included in the position condition. It is thus determined that the position condition is not met. In the case where the position information acquired in step S401 is Long. 139.32.23.3 E, Lat. 35.23.46.9 N, on the other hand, the distance from the center point to the present place is calculated as 60 m, which is within the radius included in the position condition. Thus, it is determined that the position condition is met. In the way described above, it is determined whether the position condition is met or not. In the case where it is determined in the position condition determination process described above that the position condition is satisfied, the process proceeds to step S403, while in the case where it is determined that the position condition fails to be satisfied, the process returns to step S401.

Finally, the automatic application execution processing is carried out for executing an application corresponding to the application ID in registration (step S403).

Through the procedure described above, a designated application is executed only in the case where the present place of the portable terminal 100 satisfies the designated position condition.

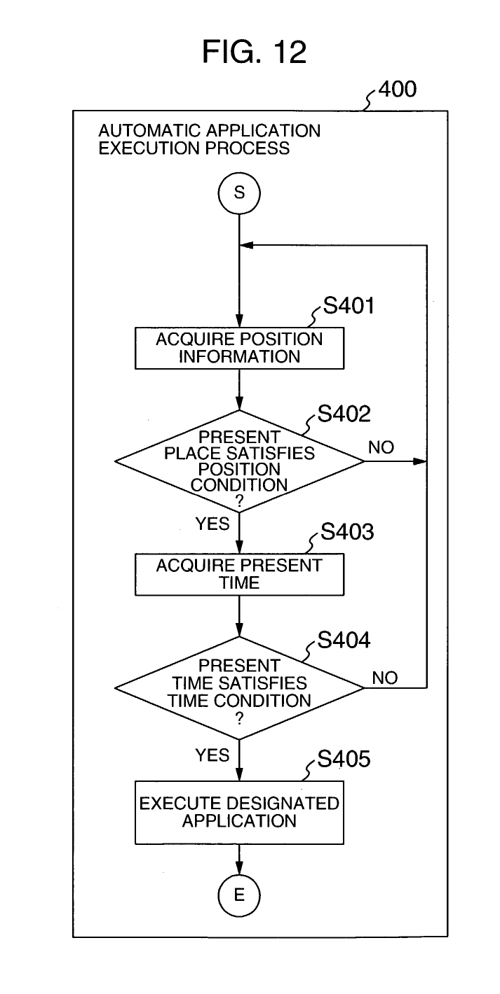

In the case where the time is added as a condition for automatic execution of an application, the automatic application execution processing 400 as shown in FIG. 12 is employed.

The process up to step S402 is similar to the corresponding process in FIG. 10, and therefore the process including and subsequent to step S403 will be explained. The portable terminal 100 acquires the present time using a time acquisition unit 107 (step S403). The time condition determination processing is executed for determining whether the present time acquired in step S403 meets the time condition or not (step S404). The time condition determination processing may be either the process for determining whether a set time has passed or not or the process for determining whether it is within a predetermined time length, say, 10 minutes or not from a set time point. Consider a process in which it is determined that the time condition is met as far as it is within 10 minutes from a set time, for example. Assuming that the set time condition is “10: 31, Feb. 19, 2002”, it is determined that the time condition fails to be met in the case where the acquired present time is “8:45, Feb. 19, 2002”. In the case where the acquired present time is 10:35, Feb. 19, 2002”, on the other hand, it is determined that the time condition is met. In the case where it is determined in the aforementioned time condition determination processing that the determination result obtained meets the time condition, the process proceeds to step S405, while in the case where it is determined that the time condition is not met, the process returns to step S401. In the case where the time condition is not set, this process is executed always on the assumption that the time condition is met. Finally, the automatic application execution processing is carried out for executing an application registered (step S405).

By way of the procedure mentioned above, a designated application is executed in the case where the present place and the present time of the portable terminal 100 meet the designated position condition and the designated time condition, respectively.

According to this embodiment, it is determined whether the time condition is met or not in the case where the position condition is met. The invention is not limited to this method, but the reverse procedure may be employed with equal effect. Specifically, it may be determined whether the position condition is met or not in the case where the time condition is met. The acquisition of the time information imposes a lesser burden on the CPU than the acquisition of the position information. Therefore, the latter method has the advantage of a smaller battery consumption.

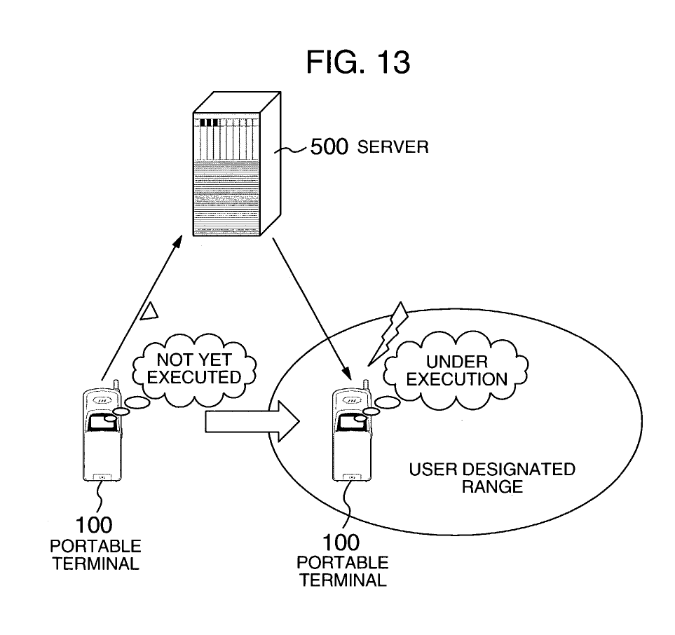

Next, an embodiment in which an application is automatically executed in a system configured of a portable terminal and a server according to the invention will be briefly explained with reference to FIG. 13.

In FIG. 13, numeral 100 designates a portable terminal. The portable terminal 100 includes a position information acquisition unit for acquiring the position information capable of specifying the present place. The position information thus acquired is transmitted to a server. The position information acquisition unit which may be a GPS (global positioning system) is a device for acquiring the data received from a GPS satellite or a device for calculating the present place of the portable terminal from the data received from a GPS satellite. Also, upon receipt of an application execution request message sent from the server and having stored therein an application ID for uniquely identifying the application, the application ID in the application execution request message is read out. The portable terminal is searched for an application corresponding to this application ID, and in the presence of such an application, the particular application is executed by an automatic application execution unit. Assume that an application to be executed is stored in the portable terminal 100 in advance. In FIG. 13, numeral 500 designates a server. The server 500 has registered therein an application ID constituting an identifier for uniquely identifying the application to be automatically executed and the position condition making up a condition for the place where the application is to be executed. The server 500, upon receipt of the position information of the portable terminal 100 from the particular portable terminal 100, determines whether the present place of the portable terminal obtained from the position information satisfies the position condition registered, and only in the case where the position condition is so satisfied, sends an application execution request message containing the application ID to the portable terminal that has sent the position information. The portable terminal 100 that has received the application execution request message automatically executes the application by way of the automatic application execution unit.

As an alternative, the unit for acquiring the present time may be added to the server 500 so that the time condition for automatic execution is registered in the server 500. The determination whether the present time satisfies the time condition or not is added to the automatic execution determination upon receipt of the position information. In the case where the position condition and the time condition are both met, the application execution request message is transmitted to the portable terminal.

Further, the position condition, the time condition and the application ID input to the portable terminal may be transmitted to the server 500 and registered in the server 500.

The aforementioned procedure makes it possible to realize the function of executing an application automatically with the present place as a trigger.

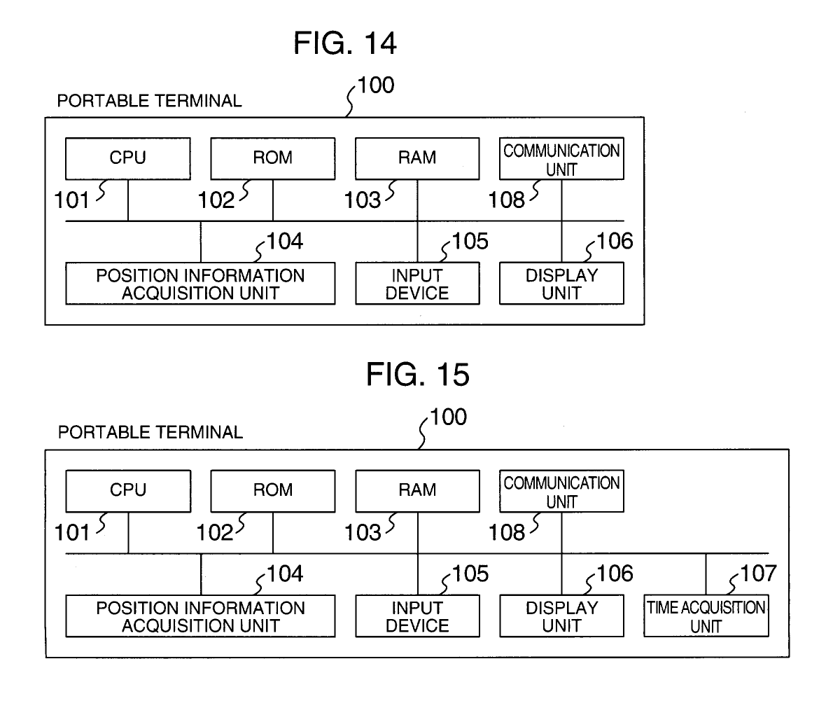

Next, a hardware configuration of a portable terminal in a program execution system configured of the portable terminal and a server according to the invention will be explained with reference to FIG. 14.

In FIG. 14, numeral 101 designates a CPU for executing various programs for controlling the peripheral units, data processing and communication. Numeral 102 designates a ROM for storing various programs and data for the data processing and communication. Numeral 103 designates a RAM which is used for executing by loading various programs for data processing and communication from the ROM and storing data. Numeral 104 designates a position information acquisition unit used for acquiring the position information capable of identifying the present place. The position information acquisition unit 104 is a GPS antenna, for example. Numeral 105 designates an input device used in the operation for the application to be executed and the operation for various setting processes. The input device 105 is a button or a joystick, for example. Numeral 106 designates a display unit used for displaying a setting screen for changing the setting for automatic application execution or displaying the application that has been executed in the portable terminal 100. The display unit 106 is a LCD (liquid crystal display), for example. Numeral 108 designates a communication unit used bidirectionally with the server 500. The communication unit 108 is a radio unit, for example.

When taking into consideration the time as well as the place for determining whether an application is to be automatically executed or not, a hardware configuration of the portable terminal as shown in FIG. 15 is employed. A time acquisition unit 107 used for acquiring the present time is added to the portable terminal shown in FIG. 14.

Next, an explanation will be given of the process for registering the position condition and an application to be executed automatically in the portable terminal 100.

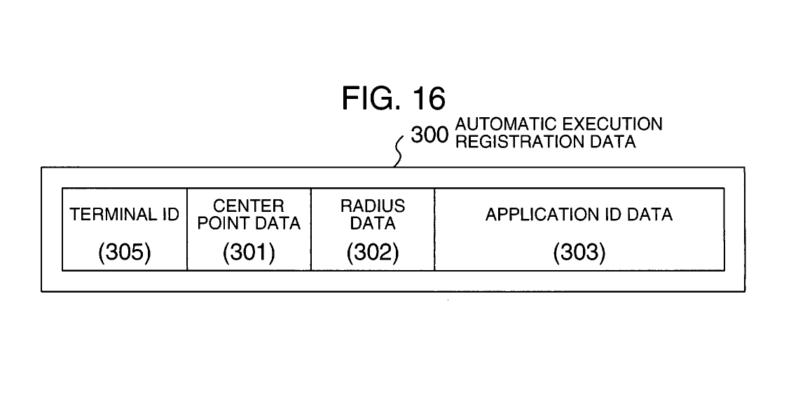

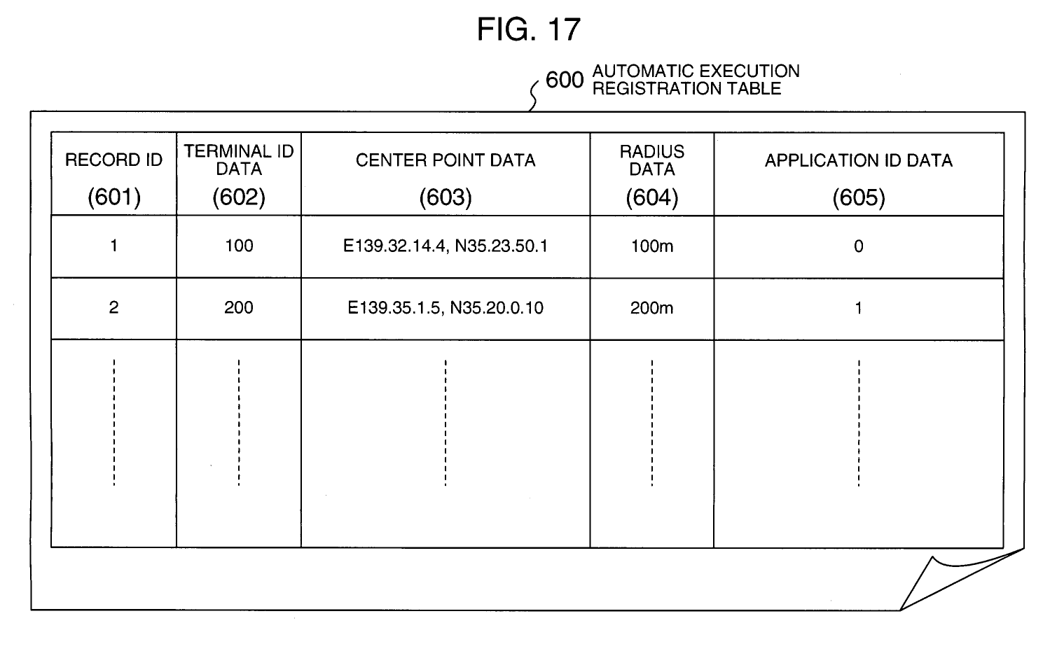

The condition for automatic execution is input through a procedure similar to the registration process realized with a portable terminal unit. The portable terminal 100 transmits an automatic execution registration data 300 as shown in FIG. 16 to the server 500. As shown in FIG. 16, the automatic execution registration data 300 is configured of four data including a terminal ID data 305 for storing the terminal ID making up an identifier for uniquely identifying a portable terminal, a center point data 301 making up a position condition, a radius data 302 and an application ID data 303 for uniquely identifying the application to be executed automatically. The server 500 that has received the automatic execution registration data 300 extracts the terminal ID, the center point data making up the position condition, the radius data and the application ID from the automatic execution registration data 300, and registers the extracted data in an automatic execution registration table 600 held by the server 500 as shown in FIG. 17. The automatic execution registration table 600 is configured of five data including a record ID 601 for uniquely identifying the record, a terminal ID 602 for identifying the portable terminal constituting a destination of transmission of an application execution request message, a center point data 603 making up the position condition, a radius data 604 and an application ID 605 indicating an application to be executed. The terminal ID, the center point data, the radius data and the application ID that have been extracted are stored in the terminal ID 602, the center point data 603, the radius data 604 and the application ID 605, respectively, and held in the server 500. Through this procedure, the position condition of an application and the application ID input through the portable terminal 100 are registered in the server 500.

In the case where the position condition is described in the header information of the application, a method may be employed in which the portable terminal 100, after being confirmed by the user, transmits the automatic execution registration data 300 created from the position condition in the header information to the server 500, which in turn registers them.

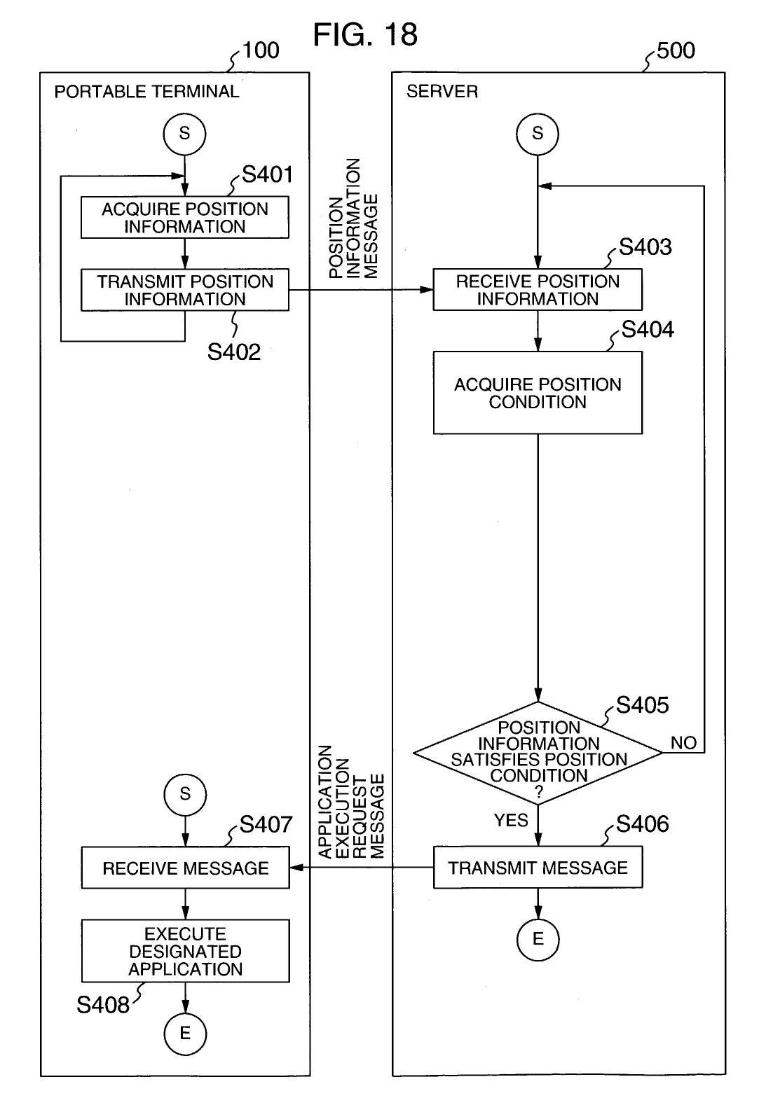

Next, the automatic execution process 400 for the application registered in the portable terminal 100 will be explained with reference to FIG. 18.

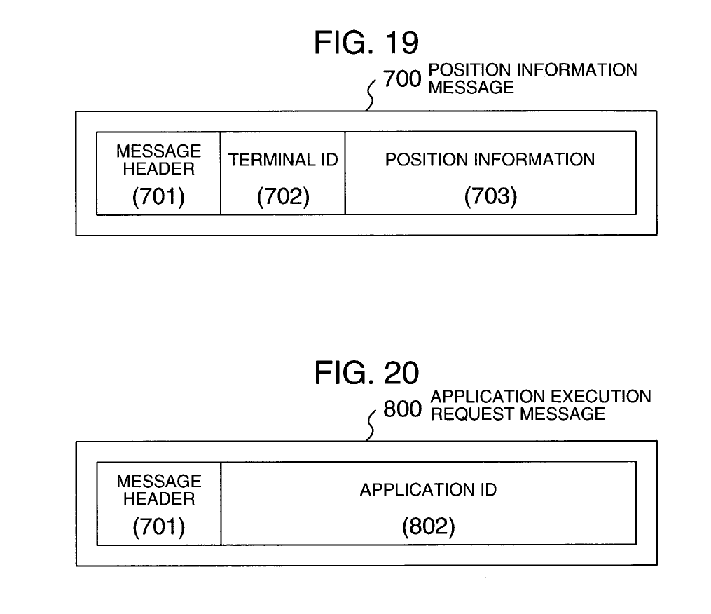

First, the portable terminal 100 registers the execution condition in the server 500 and then acquires the position information using the position information acquisition unit 104 (step S401). Then, the position information message 700 including the position information acquired in step S401 is transmitted to the server 500 by the portable terminal 100 (step S402). The position information message 700, as shown in FIG. 19, is configured of a message header 701 indicating the type of the message, a terminal ID 702 for uniquely identifying the portable terminal constituting the origin of transmission and the position information 703 acquired in in step S401. The process of steps S401 and S402 is repeatedly executed until an application execution request message 800 is received from the server 500 or the user cancels the process.

Also, the server 500, upon receipt of the position information message 700 transmitted from the portable terminal 100 in step S402 (step S403), extracts a record coincident with the terminal ID 702 in the position information message 700 received in step S403, out of the automatic execution registration table 600 held therein, and thus acquires the position information and the application ID from the extracted record (step S404). Next, the present place of the portable terminal is specified from the position information transmitted from the portable terminal 100, and the execution condition determination processing is executed to determine whether the position condition acquired in step S404 is satisfied or not (step S405). In the case where it is determined the condition is not satisfied in the execution condition determination processing described above, the process returns to step S403, while in the case where it is determined that the condition is satisfied, the application execution request message 800 is transmitted toward the portable terminal corresponding to the terminal ID in the position information message acquired in step S403 (step S406). The application execution request message 800, as shown in FIG. 20, is configured of a message header 801 describing the type of the message and an application ID 802 for uniquely identifying the application to be executed automatically.

Finally, the portable terminal 100, upon receipt of the automatic application execution request message 800 transmitted from the server 500 in step S406 (step S407), causes to execute the application corresponding to the application ID 802 for uniquely identifying the application for automatic execution included in the application execution request message 800 (step S408).

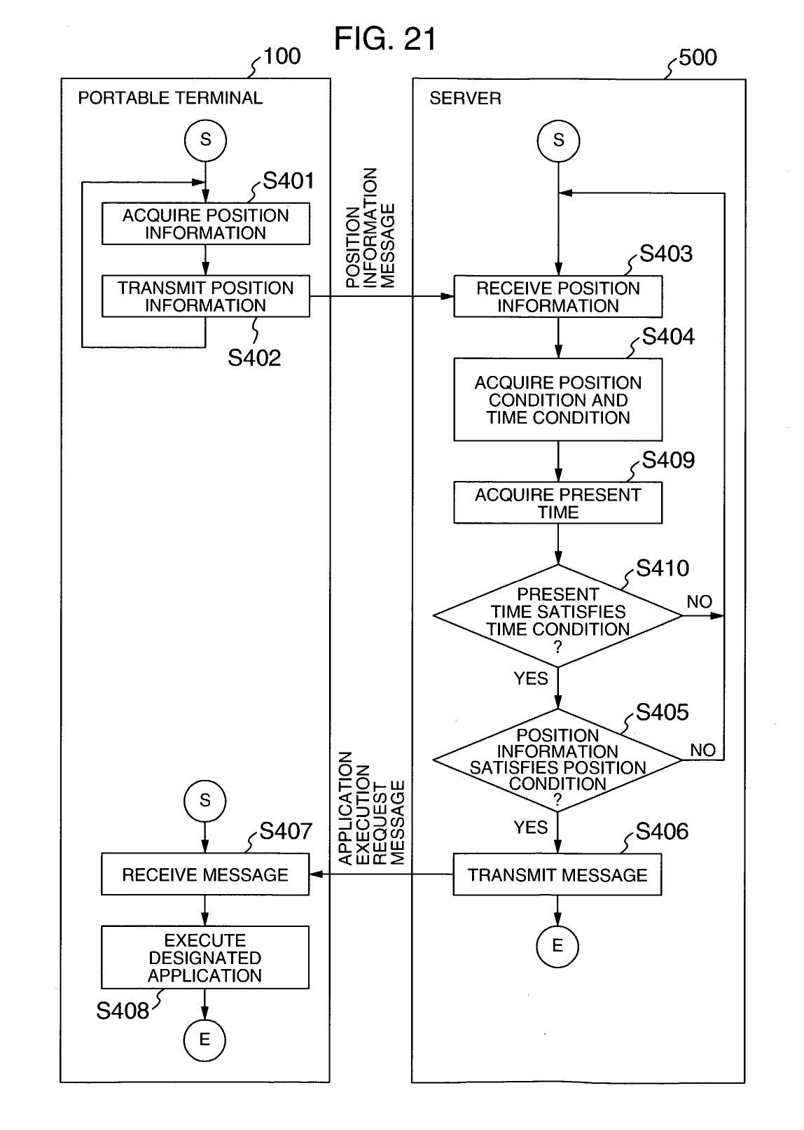

In the case where the time condition is included in the execution conditions registered in the server 500, the execution time data indicating the time at which the execution of the application is desired is added to the automatic execution registration data 300 and the automatic execution registration table 600, and the process is changed as shown in FIG. 21. In step S404, the record coincident with the terminal ID corresponding to the portable terminal that has transmitted the position information is extracted from the automatic execution registration table 600 held by the server 500. In this way, the center point data and the radius data making up the position condition, the execution time data constituting the time condition and the application data for uniquely identifying the application to be automatically executed are acquired from the extracted record. After step S404, the present time is acquired (step S409), and it is determined whether the present time acquired in step S409 and the position information of the portable terminal 100 received in step S403 satisfy the position condition and the time condition, respectively, making up the conditions for executing the application, acquired in step S404 (step S410). In the case where the application execution condition is met, the process proceeds to step S406, while in the case where the application execution condition fails to be met, the process returns to step S403.

In the way described above, the function of executing an application automatically can be realized with the present place as a trigger.

As described above, in a portable terminal, a server and a program execution system having the function of automatic execution according to this embodiment, it is determined whether a designated position condition is met after the portable terminal 100 acquires the present place, and in the case where the condition is met, the designated application is executed. In this way, the execution of an application with the present place as a trigger can be realized.

As a result, it becomes possible to automatically execute an application frequently used at a specified place, thereby making it possible to obtain a portable terminal, a server and a program execution system with an improved user convenience.

Also, a portable terminal according to the embodiment can be obtained by downloading a program to a portable terminal.

It will thus be understood from the foregoing description that according to an embodiment of the invention, there is provided a portable terminal and a system having the function of automatic execution in which an application can be automatically executed with the present place as a trigger. As a result, an application often used at a specific place can be automatically executed for an improved convenience of the user.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A portable terminal comprising:
an application registration unit for registering an application;
an application execution unit for executing the registered application;
an execution condition registration unit for registering the condition for the place where the application is to be automatically executed, the condition for the execution time and said application to be executed automatically;
a present place acquisition unit for acquiring the present place of said portable terminal; and
a control unit for causing the application registered in said execution condition registration unit to be executed in the case where the present place acquired by s aid present place acquisition unit meets the condition for the place and the execution time recorded by said execution condition registration unit.

2. A portable terminal according to claim 1, further comprising an execution condition extraction unit for extracting the place condition and the execution time condition making up the conditions for automatic execution from the header information of the application, wherein said execution condition registration unit executes a registration process for registering the execution conditions including the place condition and the execution time condition acquired from said execution condition extraction unit.

3. A portable terminal comprising:
an application registration unit for registering an application;
an application execution unit for executing the registered application;
a present place information acquisition unit for acquiring the position information capable of specifying the present place of the portable terminal;
a position information transmission unit for transmitting the position information capable of specifying the present place of the portable terminal acquired by said present place acquisition unit to a server;
an execution request receiving unit for receiving an application execution request message including an identifier for identifying an application from the server; and
a control unit for causing an application corresponding to said identifier to be executed in the case where said execution request receiving unit receives said application execution request message from said server.

4. A portable terminal according to claim 3, further comprising an execution condition extraction unit for extracting the place condition making up the condition for automatic execution from the header information of an application and an execution condition transmission unit for transmitting the place condition acquired from said execution condition extraction unit to said server.

5. A portable terminal according to claim 3, further comprising an execution condition extraction unit for extracting the place condition and the execution time condition making up the conditions for automatic execution from the header information of an application and an execution condition transmission unit for transmitting the place condition and the execution time condition acquired from said execution condition extraction unit to said server.

6. A server comprising:
a communication unit capable of communication bidirectionally with a portable terminal;
an execution condition registration unit for registering and holding the execution condition information including at least two conditions including the place condition constituting a condition for automatic execution and an identifier for identifying the application to be executed automatically;
a position information receiving unit for receiving the position information capable of specifying the present place of the portable terminal; and
an execution request message transmission unit for transmitting an application execution request message including an identifier for identifying the application contained in said execution condition information to said portable terminal that has transmitted said position information, in the case where the present place determined from the position information received from said position information receiving means satisfies the place condition included in the execution condition information registered by said execution condition registration means.

7. A server according to claim 6, further comprising a present time acquisition unit for acquiring the present time,
wherein said execution condition registration unit registers the execution condition information with the execution time condition for automatic execution added thereto, and
wherein said execution request message transmission unit transmits an application execution request message including an identifier for identifying the application included in said execution condition information to the portable terminal in the case where the present place determined from the position information received from said position information receiving unit and the present time acquired from said present time acquisition unit satisfy the place condition and the execution time condition, respectively, registered in said execution condition registration unit.

8. A program for causing a portable terminal having a control unit, a storage unit, a time acquisition unit and a position acquisition unit to execute the steps:
that said storage unit stores the place condition for automatic execution of said application, the execution time condition and the application to be automatically executed;
that said control unit determines whether the present place acquired by said position acquisition unit satisfies the place condition stored in said storage unit;
that said control unit determines whether the present time acquired by said time acquisition unit satisfies the execution time condition stored in said storage unit; and
that said control unit automatically executes the application stored in said storage unit in the case where it is determined that said place condition and said execution time condition are satisfied.
